(19) United States
(12) Patent Application Publication
(10) Pub. No.: US 2003/0106857 A1
(43) Pub. Date: Jun. 12, 2003

(54) Removing sulfuric acids from solids

(76) Inventor: Gene E. Lightner, Federal Way, WA (US)

Correspondence Address: Gene E. Lightner, 706 SW 296th St., Federal Way, WA, 98023-3549, US

(21) Appl. No.: 10/016,503

(22) Filed: Dec. 10, 2001

(51) Int. Cl. B01D 43/00

(52) U.S. Cl. 210/767

(57) ABSTRACT

A method for removing aqueous sulfuric acid from solids is presented. By providing an organic solvent inert, and insoluble, to aqueous sulfuric acid and subjecting solids, containing aqueous sulfuric acid, to the insoluble solvent results in a lower phase of aqueous sulfuric acid and an upper phase of solids contained within the solvent. Each phase is then separated from the solvent. The organic solvent must be of density less than the aqueous sulfuric acid and of density greater than the solids. The upper phase of the solids are sugars or lignins created from hydrolysis of a biomass. The lower phase of aqueous sulfuric acid, freed from the solids, contains about 70% sulfuric acid and is available for recycle for hydrolysis of a biomass. Thereby aqueous sulfuric acid is recovered from solids containing aqueous sulfuric acid, and solids substantially devoid of sulfuric acid, are formed.

### BACKGROUND OF THE INVENTION

Present day interest in hydrolysis of biomass is to provide an alternative fuel source to avoid dependence on unreliable imported petroleum crude oil for liquid fuels. Cellulose and hemicellulose within a biomass are hydrolyzed by sulfuric acid to form lignins and a hydrolysate containing sulfuric acid and hydrolysis products. Lignins containing sulfuric acid result from this practice. Solid sugars containing sulfuric acid are also obtained from this procedure.

“Process for production of solid glucose” is a title within a patent contributed by Lightner, in U.S. Pat. No. 5,868,851, in which solid glucose is obtained from a hydrolysate derived from acid hydrolysis of a biomass. Solid glucose, containing residual acid, is subjected to extraction to free most of the acid adhering to the solid glucose. The solid glucose, obtained from a hydrolysate, is extracted with water or a solvent of ketones or alcohols to result in solid glucose mostly free of acid.

Bairrier, et. al., within Biochemical Conversion Program Semi-Annual Review Meeting 10-12 Jun. 1985, in a report entitled “ETHANOL FROM AGRICULTURAL FEEDSTOCKS,” from FIG. 1 page 341, designate water extraction of residue from hydrolysis of corn stover from a pilot plant built by TVA. Extracted residue contains lignins from hydrolysis of corn stover.

It is believed that a simple economical method for removing sulfuric acid from solids produced by hydrolysis of a biomass does not presently exist.

It is an object of this invention to obviate the limitations or disadvantages of the prior art.

An essential object of this invention is to remove sulfuric acid from solids derived from hydrolysis of a biomass.

A direct object of this invention is to employ a solvent to remove sulfuric acid from solids derived from hydrolysis of a biomass.

A distinct object of this invention is to derive lignins substantially devoid of sulfuric acid.

A secondary object of this invention is to derive solid sugars substantially devoid of sulfuric acid.

Another object of this invention is to obtain sulfuric acid for recycle.

With the above and other objects in view, this invention relates to the novel features and alternatives and combinations presently described in the brief description of the invention.

### PRINCIPLES APPLIED BY THE INVENTION

The principles applied herein derive solids from acid hydrolysis of a biomass. Typical dry wood, a biomass, composition is: lignin 25%, hemicellulose 25%, amorphous cellulose 10%, and crystalline cellulose 40%, thus biomass contains cellulose and hemicellulose. Percentages of components can vary depending on biomass properties. Biomass is often selected from the group consisting of wood, lignocellulose materials and paper, including an individual or a combination of these thereof.

Solids derived from acid hydrolysis of a biomass exclude lignins and solid sugars. Awareness that sulfuric acid exists as a liquid, within solids containing sulfuric acid, depend on a liquid solvent to remove sulfuric acid from insoluble solids. Density of sulfuric acid at about 73% is 1.65 grams per cubic centimeter specified within HANDBOOK of CHEMISTRY and PHYSICS, 56th EDITION 1975-1976, page B-148. Density of solid glucose, op cit., specified within page C-311, is 1.56 grams per cubic centimeter. Density of solid xylose, op cit., specified within page C-540, is 1.56 grams per cubic centimeter. Within LIGNINS, 1971, specified within page 704, specific volume of bulk lignins is about 0.7 mg/g. thus density of lignins is about 1.43 grams per cubic centimeter.

In order for removal of sulfuric acid from insoluble solids, solids containing sulfuric acid are combined with a solvent to separate liquid sulfuric acid and form an insoluble phase within the solvent. Density of the solvent must be of density limits of 1.65 grams per cubic centimeter to about 1.43 grams per cubic centimeter in order for solids to float above the solvent and sulfuric acid to settle as a phase within the solvent.

Properties of chlorinated solvents presented within Appendix B from the publication, “Chlorinated Solvents”, provided by Dow Chemical Company, list chlorinated solvents ranging in specific gravity from 1.32 to 1.169 having somewhat limited solubility in water.

Considerable effort has formerly been expended to remove sulfuric acid from solids produced from acid hydrolysis of a biomass.

### BRIEF DESCRIPTION OF THE INVENTION

The present invention in its broadest aspect, comprises a method to remove aqueous sulfuric acid from solids produced by acid hydrolysis of a biomass. Upon providing solids containing aqueous sulfuric acid, and subjecting the solids to an organic solvent, inert and insoluble, to the aqueous sulfuric acid. From solids, containing aqueous sulfuric acid, aqueous sulfuric acid settles in the solvent to form a lower phase of aqueous sulfuric acid. The lower phase of aqueous sulfuric acid is recycled and employed for hydrolysis of a biomass. Solids, substantially freed from aqueous sulfuric acid, then float on the solvent to form an upper phase of solids substantially devoid of sulfuric acid, thereby providing solids substantially devoid of sulfuric acid and providing aqueous sulfuric acid substantially devoid of solvent.

Characteristics of the invention include;

Lignins resulting from hydrolysis of a biomass provide solids containing aqueous sulfuric acid.

Solids, containing aqueous sulfuric acid, are mingled with an organic solvent to form a phase of aqueous sulfuric acid and a phase of solids substantially devoid of sulfuric acid.

The organic solvent is of density less than the aqueous sulfuric acid and of density greater than the solids.

The organic solvent is both inert and insoluble to aqueous sulfuric acid and is selected from the group consisting of hydrocarbons, halogens and organic acids including an individual or combination thereof.

Aqueous sulfuric acid is freed from the solids containing aqueous sulfuric acid and settles in the solvent to form a lower phase of aqueous sulfuric acid.

Solids, substantially devoid of sulfuric acid. float in the solvent to form an upper phase.

The resulting lower phase of aqueous sulfuric acid is recycled for hydrolysis of a biomass. achieved in counter current fashion.

The method is executed and achieved in continuous and counter current fashion.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to dissolve sugars in fermentation broth.

FIG. 3 is a flow sheet denoting a method to recover solvent and heterocyclic compounds by distillation.

### DETAILED DESCRIPTION OF THE PREFERRED EMBODIMENT

In the preferred embodiment of the present invention, solids are removed from concentrated sulfuric acid hydrolysis of a biomass.

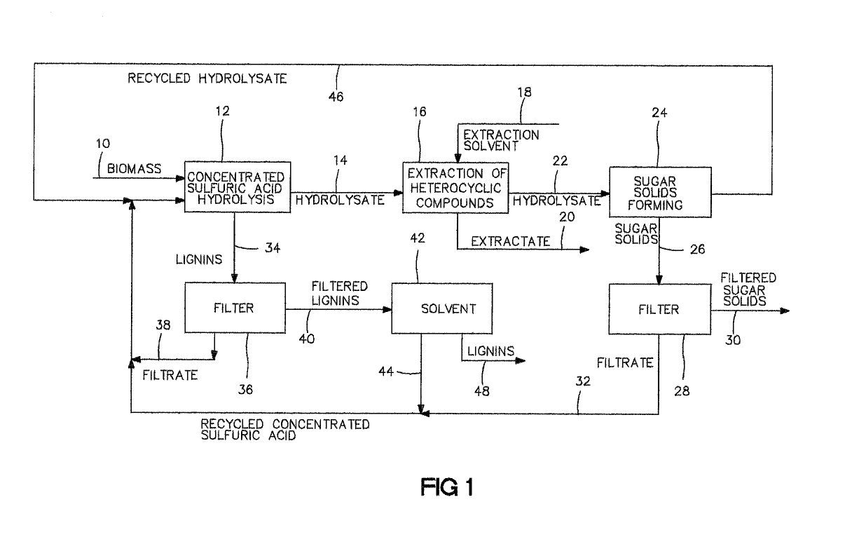

The flow diagram of FIG. 1 illustrates the general preferred embodiment of the present invention. In the diagram, rectangles represent stages, operations or functions of the present invention and not necessarily separate components. Arrows indicate direction of flow of material in the method.

Referring to FIG. 1, biomass 10 and recycled concentrated sulfuric acid 44 is conveyed to a concentrated sulfuric acid hydrolysis stage 12 and produces a hydrolysate 14 containing sugars and heterocyclic compounds derived from hydrolysis of a biomass. Hydrolysate 14, containing heterocyclic compounds, is subjected to extraction of heterocyclic compounds by stage 16 with extraction solvent 18 for removal of heterocyclic compounds contained in extractate 20 and producing hydrolysate 22, substantially devoid of heterocyclic compounds. Hydrolysate 22, is transferred to sugar forming stage 24 to create solid sugars 24. Solid sugars 26 are removed from the sugar solids forming stage 24, along with recycled hydrolysate 46, is created and removed from the sugar solids forming stage 24. Removed solid sugars 26 are transferred to filter stage 28, to produce filtered sugars 30 and filtrate 32 to be combined with recycled concentrated sulfuric acid 44. Lignins 34, remaining from hydrolysis of a biomass, are removed from concentrated sulfuric acid hydrolysis stage 12, and conveyed to filter stage 36 to form filtrate 38, recycled to concentrated sulfuric acid hydrolysis stage 12 and produce filtered lignins 40. Filtered lignins 40 are transferred to solvent stage 42 to separate concentrated sulfuric acid from filtered lignins to form lignins 48 and derive concentrated sulfuric acid 44 for recycle. Concentrated sulfuric acid contained within filtered lignins 40 is in the form of a liquid and settles within the solvent contained within solvent stage 42. Solvent within solvent stage 42 possesses a density less than that of concentrated sulfuric acid 44 and a density greater than that of lignins 48. Lignins 48, substantially devoid of sulfuric acid, are produced by floating on the solvent after removal of concentrated sulfuric acid contained within the filtered lignins. Accordingly the solvent serves only to separate concentrated sulfuric acid contained within filtered lignins 40, to produce lignins 48, remains resident within solvent stage 42. Removal of heterocyclic compounds from hydrolysate 14, contributes to withdrawal of heterocyclic compounds from solid sugars. Heterocyclic compounds such as hydroxymethylfurfural and furfural within hydrolysate 14 are considered undesirable within sugars for anticipated fermentation.

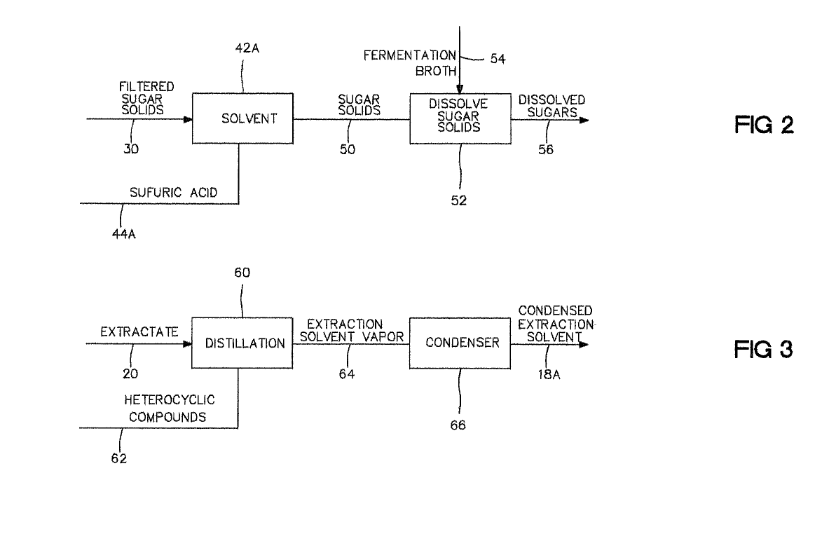

Referring to FIG. 2, filtered solid sugars 30 are transferred to solvent stage 42A to separate concentrated sulfuric acid from filtered solid sugars to form sugar solids 50, substantially devoid of sulfuric acid, and produce sulfuric acid for recycle 44A. Sugar solids 50 and fermentation broth 54 are transmitted to dissolve sugar solids stage 52 to create a solution of sugars dissolved in fermentation broth 56 Accordingly the solvent remains resident within solvent stage 42A and serves only to separate concentrated sulfuric acid contained within filtered sugar solids 30 and produce sugars solids 50 substantially devoid of sulfuric acid. Solvent within solvent stage 42A possess a density less than that of concentrated sulfuric acid 44A and a density greater than that of solid sugars 50.

Referring to FIG. 3, extractate 20, transferred and distilled, within distillation stage 60 forms extraction solvent vapor 64, condensed in condenser stage 66, to form condensed extraction solvent 18A to become solvent 18 for recycle. Raffinate from distillation produce heterocyclic compounds 62. Details of distillation stage 60 and condenser stage 66 are nonessential fine points and accordingly omitted from FIG. 3. Hence heterocyclic compounds 62 are removed from extractate 20, derived from hydrolysate 14.

What is claimed is:

1. A method for removing aqueous sulfuric acid from solids which comprises:
providing solids containing aqueous sulfuric acid, and
providing an organic solvent inert and insoluble within said aqueous sulfuric acid, and
subjecting said solids containing aqueous sulfuric acid to said solvent resulting in a lower phase of said aqueous sulfuric acid and an upper phase of said solids thereby providing aqueous sulfuric acid substantially devoid of solvent from solids containing aqueous sulfuric acid to render solids substantially devoid of aqueous sulfuric acid.

2. The method of claim 1 wherein said organic solvent is of density less than said aqueous sulfuric acid and of density greater than said solids, substantially devid of aqueous sulfuric acid.

3. The method of claim 1 wherein said upper phase of said solids is lignins created from hydrolysis of a biomass.

4. The method of claim 3 wherein the upper phase of lignins is combined with water to separate adhering solvent.

5. The method of claim 1 wherein said upper phase of said solids are sugars created from hydrolysis of a biomass.

6. The method of claim 5 wherein the upper phase of sugars is dissolved in fermentation broth to form a solution.

7 The method of claim 1 wherein said lower phase of aqueous sulfuric acid contains about 70% sulfuric acid.

8. The method of claim 1 wherein said inert and insoluble organic solvent is selected from the group consisting of hydrocarbons, halogens and organic acids including an individual or combination thereof.

9. The method of claim 1 wherein said method is achieved in counter current fashion.

10. The method of claim 1 wherein said method is executed in continuous fashion.

11. The method of claim 1 wherein said solids are obtained from acid hydrolysis of a biomass.

12. The method of claim 11 wherein the biomass is selected from the group consisting of wood, lignocellulose materials and paper, including an individual or a combination thereof.
